(19) United States
(12) Patent Application Publication
(10) Pub. No.: US 2005/0149509 A1
(43) Pub. Date: Jul. 7, 2005

(54) Information processing method, information processing apparatus, control program, and storage medium

(75) Inventors: Yuji Kobayashi, Kawasaki (JP); Daiki Suzuki, Kawasaki (JP); Tomonori Kudo, Yokohama (JP); Masashi Takizawa, Yokohama (JP); Shuji Ichikawa, Kawasaki (JP); Koji Maekawa, Kawasaki (JP); Ken-ichi Abe, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/014,951

(22) Filed: Dec. 20, 2004

(30) Foreign Application Priority Data
Dec. 24, 2003 (JP) 2003-427613

(51) Int. Cl. G06F 7/00

(52) U.S. Cl. 707/3

(57) ABSTRACT

A transmission path which transmits a search request between a plurality of information processing apparatuses is determined. Search request information containing pieces of information of the determined transmission path and a self host is transmitted. A search result obtained by searching for on the basis of the search request by the information processing apparatus which receives the search request information, and the search request information transmitted on the basis of the transmission path by the information processing apparatus are received.

### FIELD OF THE INVENTION

The present invention relates to an information processing method, information processing apparatus, control program, and storage medium for searching for pieces of information distributed and stored in a plurality of host computers connected to a network.

### BACKGROUND OF THE INVENTION

As a search device which searches for data present on a host computer connected to a network, a search device which has a search server operating on the host computer, and searches for the data by issuing a search request to the search server on a basis of a so-called client-server model is generally used.

However, when the plurality of host computers to be searched for are present on the network, a client must issue the search request to each of the plurality of search servers, and know its calling address and calling sequence on the network.

Alternatively, in a distributed search system and the search device in the conventional distributed search system, the following system is implemented. The host computers exchange information on the network to search for the distributed pieces of information. Host computer path information transferred in an information transfer process on the distributed network is embedded in transfer target information to control not to select redundant transfer destination host computers.

In the above-described conventional distributed search system, the host computer which has received the transfer target information containing the search request can know the host computer which has received the transfer target information. However, the host computer which has transmitted the transfer target information cannot recognize the host computer which has received the transfer target information on the network, and cannot recognize the host computer from which the search processing result can be received, thus posing a problem.

### SUMMARY OF THE INVENTION

The present invention has been made in consideration of the above problem, and has as its object to provide an information processing method, information processing apparatus, control program, and storage medium which can recognize if a plurality of search host computers distributed on a network have completely transferred pieces of search request information for a distributed information search, and can identify the host computer which could transmit transfer target information and the host computer which could not transmit the transfer target information.

In order to achieve an object of the present invention, for example, an image processing method of the present invention comprises the following arrangement.

That is, an information processing method by which a plurality of information processing apparatuses distributed and arranged on a network execute a search process, wherein
each of the plurality of information processing apparatuses executes:
a reception step of receiving search information for search request containing a transmission path on which the search information is transmitted between the plurality of information processing apparatuses;
an updating step of updating the search information received in the reception step during a search process; and
a transmission step of transmitting information about a next destination information processing apparatus to which a search request is transmitted next and a search process state to an information processing apparatus which notifies a client terminal, based on the search information updated in the updating step.

In order to achieve an object of the present invention, for example, an image processing apparatus of the present invention comprises the following arrangement.

That is, an information processing apparatus which is distributed and arranged on a network and executes a search process on the basis of a search information, comprising:
an interface which receives search information for search request containing a transmission path on which the search information is transmitted between a plurality of information processing apparatuses; and
a control device which updates the search information in accordance with a search process and transmits information about a next destination information processing apparatus to which a search request is transmitted next and a search process state to an information processing apparatus which notifies a client terminal, based on the search information updated in the updating step.

In order to achieve an object of the present invention, for example, a control program of the present invention comprises the following arrangement.

That is, a control program which causes an information processing apparatus to execute an information processing method by which a plurality of information processing apparatuses distributed and arranged on a network execute a search process, wherein
the control program in each of the plurality of information processing apparatuses comprises:
a reception step of receiving search information for search request containing a transmission path on which the search information is transmitted the plurality of information processing apparatuses;
an updating step of updating the search information received in the reception step during a search process; and
a transmission step of transmitting information about a next destination information processing apparatus to which a search request is transmitted next and a search process state to an information processing apparatus which notifies a client terminal.

In order to achieve an object of the present invention, for example, a computer-readable storage medium of the present invention comprises the following arrangement.

That is, a computer-readable storage medium which stores a program which causes an information processing apparatus to execute an information processing method by which a plurality of information processing apparatuses distributed and arranged on a network executes a search process, wherein
the program in each of the plurality of information processing apparatuses comprises:
a reception step of receiving search information for search request containing a transmission path on which the search information is transmitted between the plurality of information processing apparatuses;
an updating step of updating the search information received in the reception step during a search process; and
a transmission step of transmitting information about a next destination information processing apparatus to which a search request is transmitted next and a search process state to an information processing apparatus which notifies a client terminal.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing the arrangement of an information processing apparatus according to an embodiment of the present invention;

FIG. 2 is a view showing the arrangement of a network of the information processing apparatuses according to the embodiment of the present invention;

FIG. 3 is a host information management table according to the embodiment of the present invention;

FIG. 4 is a view showing a distributed search request message according to the embodiment of the present invention;

FIG. 5 is a view showing a distributed search request message according to the embodiment of the present invention;

FIG. 6 is a view showing a distributed search request message according to the embodiment of the present invention;

FIG. 7 is a flowchart showing a distributed information search process executed according to the embodiment of the present invention;

FIG. 8 is a flowchart showing a search request transmission path determination process executed according to the embodiment of the present invention;

FIG. 9 is a flowchart showing a search request transmission process executed according to the embodiment of the present invention;

FIG. 10 is a flowchart showing a search response reception process executed according to the embodiment of the present invention; and

FIG. 11 is a flowchart showing a search request reception process executed according to the embodiment of the present invention.

### DETAILED DESCRIPTION OF THE PREFERRED EMBODIMENT

A Preferred embodiment of the present invention will now be described in detail in accordance with the accompanying drawings.

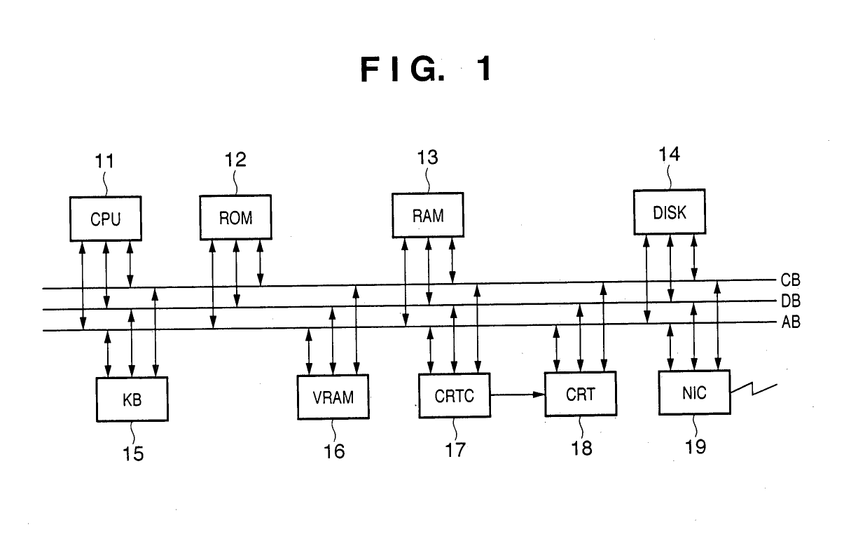

FIG. 1 is a block diagram showing the arrangement of an information processing apparatus according to an embodiment of the present invention. Referring to FIG. 1, the information processing apparatus has a processor (CPU) 11, which makes computations, logical decision, and the like for a distributed information search, and controls components connected to an address bus AB, control bus CB, and data bus DB via these buses.

The address bus AB transfers an address signal indicating the component to be controlled by the CPU 11. The control bus CB transfers and applies a control signal for each component to be controlled by the CPU 11. The data bus DB transfers data among the respective components.

A read-only fixed memory (ROM) 12 stores control program codes such as a processing program executed in this embodiment. A rewritable random access memory (RAM) 13 is used as a temporary storage of various data from the respective components. An external memory (DISK) 14 records storage information. As a storage medium for storing-the data and programs, a ROM, floppys disk, CD-ROM, DVD-ROM, memory card, magnetooptical disk, or the like can be used.

A keyboard (KB) 15 has alphabet keys, hiragana keys, katakana keys, character symbol input keys for inputting a period, comma, and the like, a search key for instructing a search, and various function keys such as cursor moving keys for instructing cursor movement, and the like.

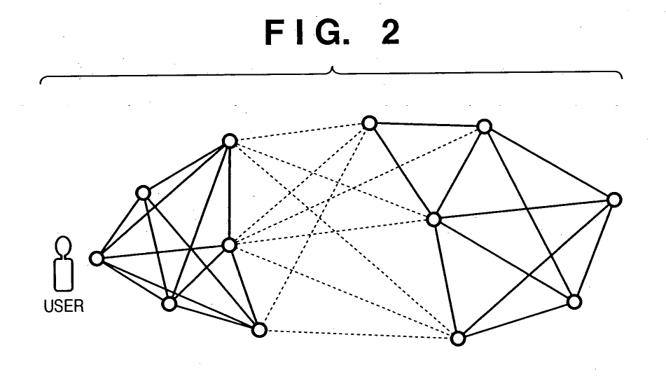

A display video memory (VRAM) 16 stores a pattern of data to be displayed. A CRT controller (CRTC) 17 displays the contents stored in the VRAM 16 on a display device CRT 18. The display device (CRT) 18 such as a cathode ray tube or liquid crystal panel makes the CRT controller control the dot display pattern and cursor display on the display device CRT. A network controller (NIC) 19 is connected to a network to connect a plurality of host computers to be described later in FIG. 2.

The information processing apparatus constructed by the aforementioned components operates in accordance with various inputs from the key board KB 15 and various inputs supplied from the network controller via the network. Upon receiving the input from the keyboard KB 15 or network controller 19, an interrupt signal is sent to the processor CPU 11. Then, the processor CPU 11 reads out various control signals stored in the external memory DISK 14, and executes various kinds of control in accordance with these control signals.

Also, this embodiment is achieved by supplying a storage medium that stores a program according to this embodiment to a system or apparatus, and by reading out and executing program codes stored in the storage medium by a computer of the system or apparatus.

The arrangement of the network which connects the plurality of information search apparatuses of this embodiment will be explained below with reference to FIG. 2. FIG. 2 is a view showing the arrangement of a network which connects the plurality of information processing apparatuses according to the embodiment. In FIG. 2, small circles respectively indicate the information processing apparatuses each of which has the arrangement described in detail with reference to FIG. 1. Solid lines indicate the arrangement of a subnet including the information processing apparatuses having a common network address. Broken lines indicate that the subnets of the information processing apparatuses are connected via a router (not shown in FIG. 2). The search request from a user is issued to the network constituted by the plurality of information processing apparatuses shown in FIG. 2.

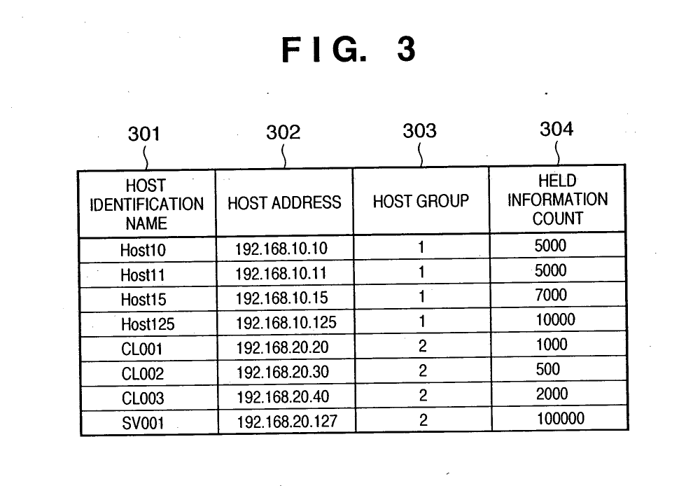

In the information processing apparatus according to this embodiment, FIG. 3 is a table showing the arrangement of management information of the information processing apparatus (to be referred to as a host hereinafter) to which the distributed information search request is transmitted. Assume that the host management information is stored in the RAM 13 or the DISK 14 shown in FIG. 1.

In FIG. 3, a host identification name 301 stores a host name in an ASCII character string. The host identification name can obtain a corresponding host address (IP address) by a known DNS (Domain Name System). A host address 302 stores the 32-bit IP address for uniquely identifying each host in the embodiment of the present invention.

A host group 303 groups the hosts in accordance with the subnet having a common network address, and stores identifiers for identifying the groups.

A held information count 304 stores an information count which can be searched for by the host. In the embodiment, the information count is a file count on a file system to be searched for.

The host management information shown in FIG. 3 is held because the hosts exchange information by autonomously establishing the connection before searching for the distributed information. Alternatively, the host management information is explicitly supplied from a system administrator for each host.

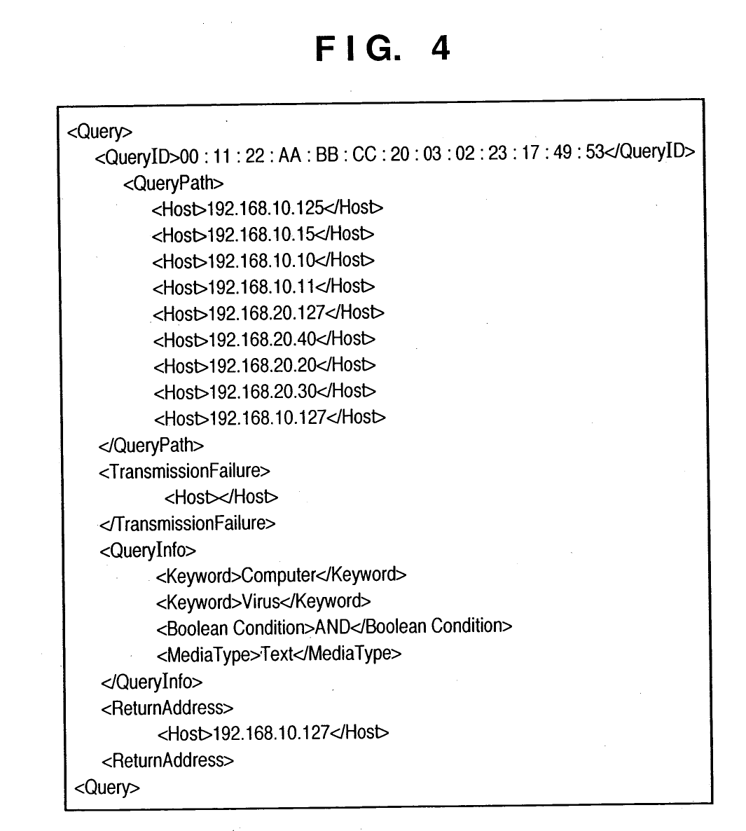

FIG. 4 is a view showing the arrangement of the distributed information search request to be transmitted to the host in the distributed information search network according to the embodiment shown in FIG. 2. FIG. 4 shows a message for transmitting the distributed information search request received by the host having the host address “192.168.10.127” to the “Host 125” having the host address “192.168.10.125”. In the embodiment, the distributed search request message is expressed in a text format with a markup tag, and is a well-formed XML document such that a part between brackets <> and </> comprises the distributed information search request in FIG. 4.

In FIG. 4, the <Query> denotes an element tag serving as the route of the distributed search request message. One distributed information search request includes at most one <Query> element.

The <QueryID> denotes an element tag which indicates identification information for uniquely identifying the distributed information search request.

The identification information of the distributed information search request is generated by combining a MAC address unique to the host which generates the distributed search request message, and the information of time at which the host generates the distributed search request message.

The <QueryPath> denotes an element tag which specifies the host to which the distributed information search request is transmitted, and designates the order of the distributed search request message to be transmitted. The <QueryPath> also designates the host address using the <Host> element. In accordance with the transmission order, the older the host is transmitted, the higher the host is arranged. Note that the host address of the host itself which generates the distributed search request message is stored at the last position of the <QueryPath> element. In FIG. 4, the message is first transmitted from the host having the host address “192.168.10.127” to the host having the host address “192.168.10.125”. Second, the message is transmitted to the host having the host address “192.168.10.15”, and to the self host having the host address “192.168.10.127” at last.

The <TransmissionFailure> denotes an element tag which stores transmission disable information, i.e., the host address of the transmission destination disable host when the distributed search request message cannot be transmitted to a destination host by a transmission error or the like in the transmission process of the distributed search request message. In FIG. 4, since there is no transmission destination disable host, the <TransmissionFailure> is empty.

The <QueryInfo> denotes an element tag which indicates the search request of the distributed information search request, and includes a <Keyword>, <BooleanCondition>, and <MediaType> elements.

The <Keyword> designates the search request keyword of the distributed information search request. The <Keyword> element can include a plurality of keywords. In FIG. 4, the <Keyword> designates two keywords, i.e., “Computer” and “Virus”. The <BooleanCondition> can designate the search condition between the keywords designated by the <Keyword> element, i.e., designate the “AND” condition which designates a logical product between the keywords, or the “OR” condition which designates a logical sum between the keywords. The <MediaType> can designate the type of media of the information to be searched for, i.e., designate the “Text” which designates a text file, “Image” which designates an image file such as a bitmap image and compressed image, “Movie” which designates a video file, and “None” which does not designate the type of media.

The <ReturnAddress> designates the information of the destination host to which the information search result for the distributed information search request is returned. In FIG. 4, the host having the address “192.168.10.127” serving as the source of the distributed search request is designated as the destination host, and the information search result of each host is transmitted to the host having the address “192.168.10.127”.

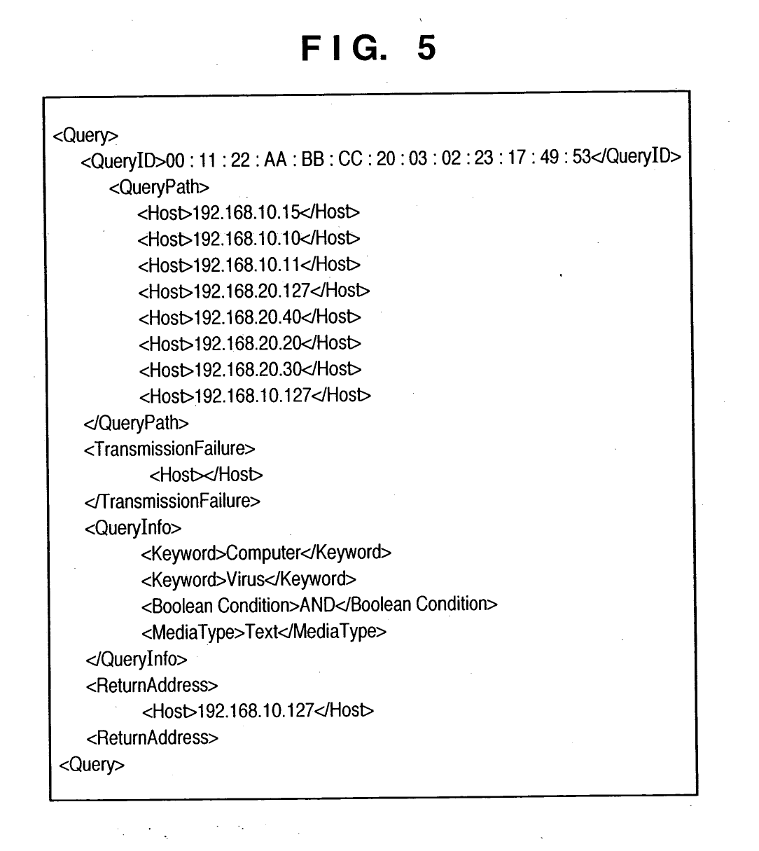

In FIG. 5, the distributed search request message shown in FIG. 4 according to the embodiment of the present invention is received by the “Host 125” having the host address “192.168.10.125”, and transmitted to the “Host 15” having the host address “192.168.10.15”. In FIG. 5, the Host 125 deletes the <Host>192.168.10.125</Host> with respect to the self host from the <QueryPath> information, updates the distributed search request message such that the <Host>192.168.10.15</Host> with respect to the destination host is at the top of the queue, and transmits the distributed search request message to a host in which search is executed next. The same distributed search request message is transmitted to the host terminal described in <ReturnAddress>. This allows the host terminal described in <ReturnAddress> to easily grasp the progress state of distributed search.

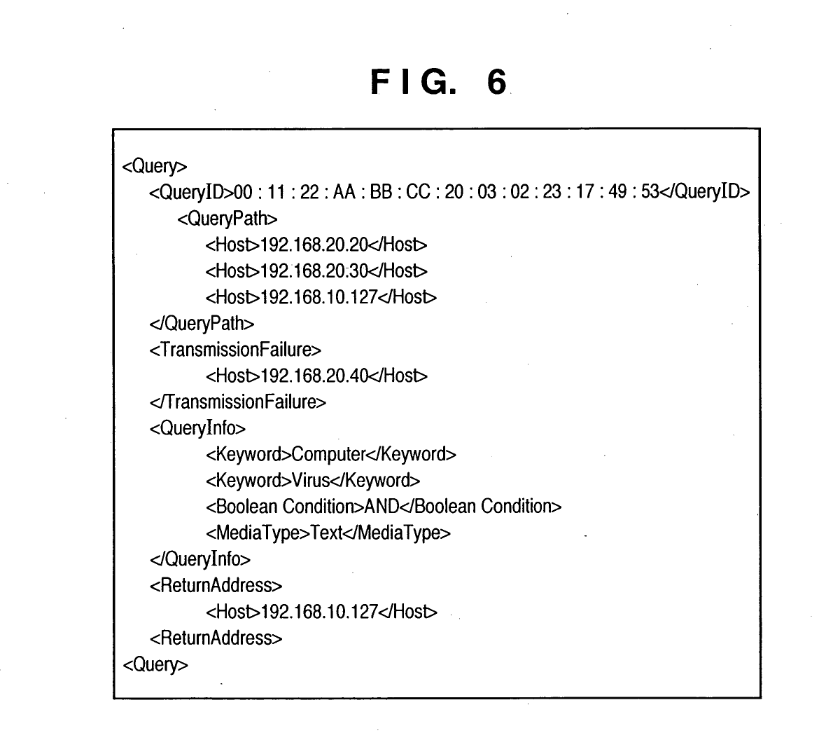

In FIG. 6, the distributed search request message shown in FIG. 4 according to the embodiment is received by the host “SV001” having the host address “192.168.20.127”. Although the host “SV001” tries to transmit the distributed search request message to the host “CL003” having the host address “192.168.20.40”, the distributed search request message cannot be transmitted to the host “CL003” since the transmission error is detected. For this reason, the distributed search request message is transmitted to the next host “CL001”.

In FIG. 6, the host “SV001” deletes the <Host>192.168.20.127</Host> of its own address from the <QueryPath> information, deletes the <Host>192.168.20.40</Host> with respect to the transmission destination disable next host, and updates the distributed search request message so that the <Host>192.168.20.20</Host> with respect to the next destination host is at the top of the queue. In addition, the host “SV001” sets the <Host>192.618.20.40</Host> with respect to the transmission destination disable host as the value of the <TransmissionFailure> element, and transmits the distributed search request message to the next host.

In this arrangement, the transmission disable host information can be transmitted to the source of the search request.

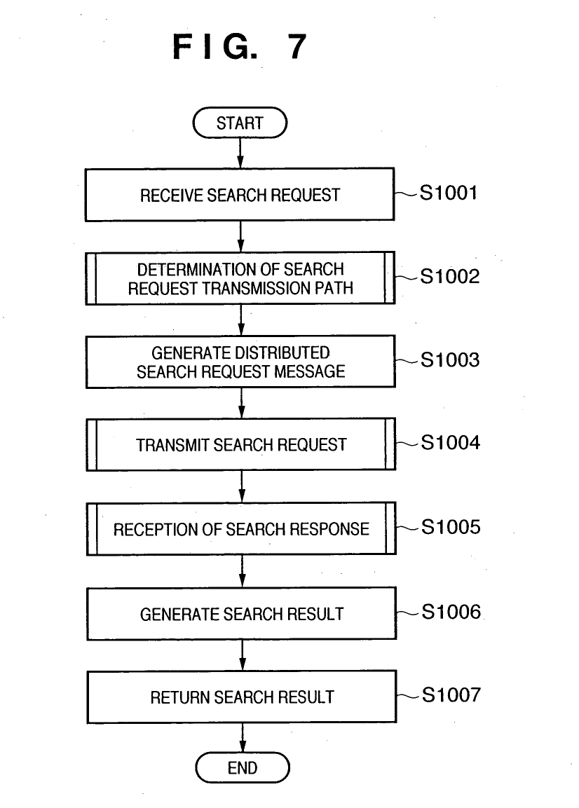

Next, the distributed information search process executed in the embodiment will be described with reference to FIG. 7. FIG. 7 is a flowchart showing the distributed information search process executed in the host terminal (i.e., the host terminal having “192.168.10.127” as an address in FIG. 4) to which the search is directly requested from the client terminal. In step S1001, the distributed information search request is received from a user (client terminal). The reception process of the distributed information search request is performed such that the search request such as the search keyword and search condition designated by a user (client terminal) in FIG. 2 is issued in accordance with a predetermined communication protocol.

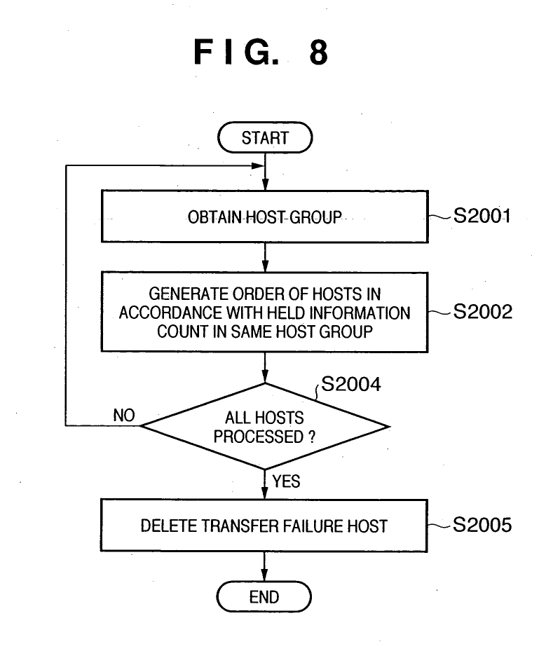

In step S1002, the host which processes the search request received in step S1001 is selected to determine a search request transmission path serving as a transmission path for transmitting the search request message. Note that the search request transmission path determination process will be described in detail with reference to FIG. 8. In step S1003, the <QueryInfo> element is generated from the search request received in step S1001, and the <QueryPath> element is generated from the search request transmission path determined in step S1002. Furthermore, the MAC address and generation time information supplied by the NIC 19 are obtained to generate the data of the <QueryID> element, and the <TransmissionFailure> element is added. Also, the host address of the self host is set to the <ReturnAddress> element to generate the distributed search request message.

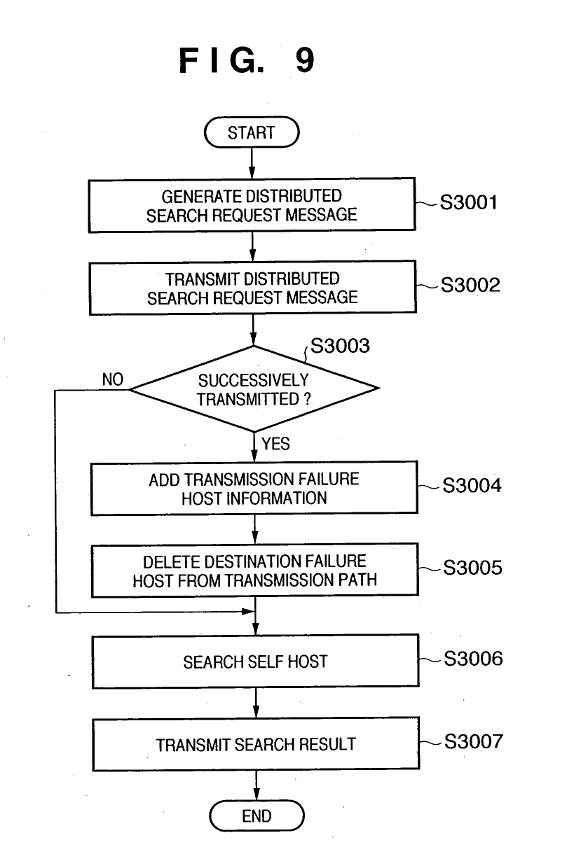

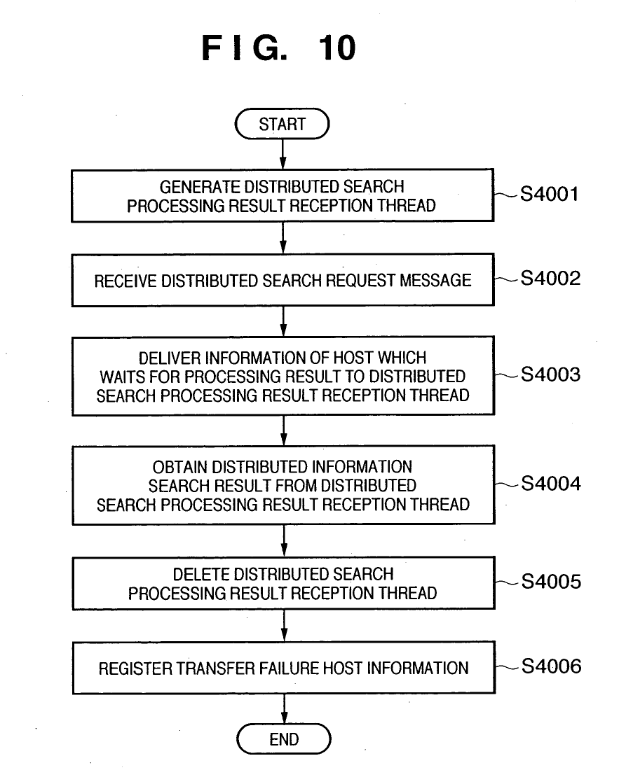

In step S1004, in accordance with the search request transmission path determined in step S1002, the distributed search request message is transmitted to the host at the top of the path. The search request transmission process will be described in detail with reference to FIG. 9. In step S1005, the search processing result responded from the host is received. The search response reception process will be described in detail with reference to FIG. 10. In step S1006, the received search result is processed into information to be presented to the client terminal. In step S1007, the processed search result is transmitted to the client terminal.

Next, the search request transmission path determination process in step S1002 will be described in detail with reference to FIG. 8. FIG. 8 is a flowchart showing the search request transmission path determination process in step S1002 of FIG. 7 in detail. In step S2001, the host management information described in detail with reference FIG. 3 is searched for to obtain the pieces of information of the hosts which belong to the same host group 303.

In step S2002, the pieces of host information obtained in step S2001 are arranged in order of the held information count 304 to determine the transmission route in the same host group. The determined transmission route is added to the search request transmission path.

In step S2004, it is checked if the all pieces of the host information in the host management information have been completely processed. If YES in step S2004, the process ends. If NO in step S2004, the flow loops to step S2001 to determine the transmission path for the next host group.

In step S2005, the transfer disable host information is read out from the transfer failure host information storage memory (hot shown). If the host information is stored as the transfer destination disable host, the host information is deleted from the search request transmission path.

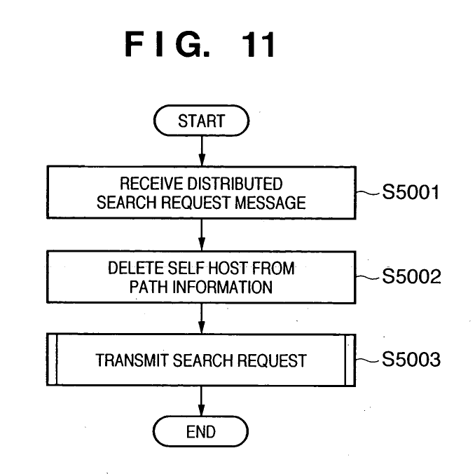

FIG. 9 is a flowchart showing the search request transmission process in step S1004 of FIG. 7 and step S5003 of FIG. 11 (to be described later) in detail. In step S3001, the distributed search request message is generated. In step S3002, the distributed search request message is transmitted to the host expressed by the top <Host> element in the <QueryPath> element of the distributed search request message. The message is transmitted/received in accordance with the TCP/IP protocol which is widely used.

In step S3003, it is checked if the distributed search request message is successively transmitted to the host. If YES in step S3003, the flow branches to step S3006. If NO in step S3003, the flow advances to step S3004. It is determined if the message is successively transmitted, by receiving an ACKNOWLEDGE message transmitted to the destination host when normally receiving the distributed search request message in the distributed search request message reception process (to be described later with reference to FIG. 11).

If the transmission fails in step S3003, the transmission failure host information is added to the <TransmissionFailure> element of the distributed search request message in step S3004, and deleted from the value of the <QueryPath> element of the distributed search request message in step S3005. The distributed search request message is transmitted to the next destination host terminal.

In step S3006, in accordance with the information indicated in the <QueryInfo> element of the distributed search request message, the information of the self host is searched for. The information search process of the self host is a known technique which is widely used, and the detailed description will be omitted.

In step S3007, the search processing result of the self host in step S3006 is transmitted to the host address indicated in the <ReturnAddress> element of the distributed search request message. In transmitting the search processing result, the search result data is also stored in a TCP packet in accordance with the TCP/IP protocol to transmit the data.

FIG. 10 is a flowchart showing the search response reception-process in step S1005 of FIG. 7 in detail. In step S4001, a reception thread which receives the search result response from each host is generated. In the reception thread, the transmitted search result is received. In step S4002, the distributed search request message is received, which has a value set in the <QuaryID> element of the distributed information search request generated in step S1003 in FIG. 7. The request source host terminal can notify the client terminal of the progress state of distributed search on the basis of this search request message.

After receiving the distributed search request message in step S4002, in step S4003, the host information except for the host information stored in the <TransmissionFailure> element of the received search request message of the search request process target host determined in step S1002 is delivered to the reception thread generated in step S4001.

The distributed search processing result reception thread receives and waits until the search results from all the hosts to which the pieces of host information have been delivered in step S4003. If the search results from the all hosts are received, the distributed information search result is delivered to a search response reception main process in step S4004. In the search response reception main process, the reception thread is discarded after receiving the distributed information search result from the reception thread.

In step S4006, the transfer failure host information indicated in the <TransmissionFailure> element of the distributed search request message is stored in the transfer failure host information storage memory (not shown).

FIG. 11 is a flowchart showing in detail the distributed search request message reception process by a host terminal except the host terminal to which the search is directly requested from the client terminal. In step S5001, the distributed search request messages are waited to be received from other hosts, and then received.

In step S5002, the information of the self host at the top of the host information list in the <QueryPath> element of the search request message is deleted from the <QueryPath> element.

In step S5003, the search request message is transmitted to the host at the top of the <QueryPath> element of the search request message. The detail of this search request transmission process is similar to the process shown in FIG. 9.

### Other Embodiment

In the above embodiment, the distributed search request message is an XML document expressed in a text format with a markup tag. However, the distributed search request message may be arranged such that the binary information which can identify the components is stored in a data packet on a transport layer.

Of course, the object of the present invention is also achieved when a storage medium which stores software program codes for realizing the functions of the above-described embodiments is provided to a system or apparatus, and the computer (or the CPU or MPU) of the system or apparatus reads out and executes the program codes stored in the storage medium.

In this case, the program codes read out from the storage medium realize the functions of the above-described embodiments, and the storage medium which stores the program codes constitutes the present invention.

The storage medium for supplying the program codes includes a floppy® disk, hard disk, magneto-optical disk, CD-ROM, CD-R, CD-RW, DVD-ROM, DVD-RAM, DVD-RW, DVD+RW, magnetic tape, nonvolatile memory card, and ROM.

The functions of the above-described embodiments are realized when the computer executes the readout program codes. Of course, the functions of the above-described embodiments are also realized when an OS (Operating System) or the like running on the computer performs part or all of actual processing on the basis of the instructions of the program codes.

Furthermore, of course, the present invention also includes a case in which, after the program codes read out from the storage medium are written in the memory of a function expansion board inserted into the computer or the memory of a function expansion unit connected to the computer, the CPU of the function expansion board or function expansion unit performs part or all of actual processing on the basis of the instructions of the program codes and thereby realizes the functions of the above-described embodiments.

As described above, in the present invention, an information processing method, information processing apparatus, control program, and storage medium have been described in detail. However, of course, various changes and modifications can be made within the spirit and scope of the present invention.

As many apparently widely different embodiments of the present invention can be made without departing from the spirit and scope thereof, it is to be understood that the invention is not limited to the specific embodiments thereof except as defined in the appended claims.

### CLAIM OF PRIORITY

This application claims priority from Japanese Patent Application No. 2003-427613 filed on Dec. 24, 2003, which is hereby incorporated by reference herein.

1. An information processing method by which a plurality of information processing apparatuses distributed and arranged on a network execute a search process, wherein
each of the plurality of information processing apparatuses executes:
a reception step of receiving search information for search request containing a transmission path on which the search information is transmitted between the plurality of information processing apparatuses;
an updating step of updating the search information received in the reception step during a search process; and
a transmission step of transmitting information about a next destination information processing apparatus to which a search request is transmitted next and a search process state to an information processing apparatus which notifies a client terminal, based on the search information updated in the updating step.

2. The method according to claim 1, wherein the search information transmitted in the transmission step contains, at a last position of the transmission path, information about the information processing apparatus which notifies the client terminal.

3. The method according to claim 1, wherein when the search information cannot be transmitted to the next destination information processing apparatus indicated in the transmission path, the information about the information processing apparatus failed to be transmitted is added to the search information as transmission disable information in the updating step.

4. An information processing apparatus which is distributed and arranged on a network and executes a search process on the basis of a search information, comprising:
an interface which receives search information for search request containing a transmission path on which the search information is transmitted between a plurality of information processing apparatuses; and
a control device which updates the search information in accordance with a search process and transmits information about a next destination information processing apparatus to which a search request is transmitted next and a search process state to an information processing-apparatus which notifies a client terminal, based on the search information updated in the updating step.

5. The apparatus according to claim 4, wherein the search information contains, at a last position of the transmission path, information about the information processing apparatus which notifies the client terminal.

6. The apparatus according to claim 4, wherein when the search information cannot be transmitted to the next destination information processing apparatus indicated in the transmission path, said control device adds the information about the information processing apparatus failed to be transmitted to the search information as transmission disable information.

7. A control program which causes an information processing apparatus to execute an information processing method by which a plurality of information processing apparatuses distributed and arranged on a network execute a search process, wherein
the control program in each of the plurality of information processing apparatuses comprises:
a reception step of receiving search information for search request containing a transmission path on which the search information is transmitted the plurality of information processing apparatuses;
an updating step of updating the search information received in the reception step during a search process; and
a transmission step of transmitting information about a next destination information processing apparatus to which a search request is transmitted next and a search process state to an information processing apparatus which notifies a client terminal.

8. The program according to claim 7, wherein the search information transmitted in the transmission step contains, at a last position of the transmission path, information about the information processing apparatus which notifies the client terminal.

9. The program according to claim 7, wherein when the search information cannot be transmitted to the next destination information processing apparatus indicated in the transmission path, the information about the information processing apparatus failed to be transmitted is added to the search information as transmission disable information in the updating step.

10. A computer-readable storage medium which stores a program which causes an information processing apparatus to execute an information processing method by which a plurality of information processing apparatuses distributed and arranged on a network executes a search process, wherein
the program in each of the plurality of information processing apparatuses comprises:
a reception step of receiving search information for search request containing a transmission path on which the search information is transmitted between the plurality of information processing apparatuses;
an updating step of updating the search information received in the reception step during a search process; and
a transmission step of transmitting information about a next destination information processing apparatus to which a search request is transmitted next and a search process state to an information processing apparatus which notifies a client terminal.

11. The medium according to claim 10, wherein the search information transmitted in the transmission step contains, at a last position of the transmission path, information about the information processing apparatus which notifies the client terminal.

12. The medium according to claim 10, wherein when the search information cannot be transmitted to the next destination information processing apparatus indicated in the transmission path, the information about the information processing apparatus failed to be transmitted is added to the search information as transmission disable information in the updating step.
